(19) United States
(12) Patent Application Publication
(10) Pub. No.: US 2015/0201646 A1
(43) Pub. Date: Jul. 23, 2015

(54) STABLE MIX OF INGREDIENTS FOR A FROZEN DESSERT

(71) Applicant: NESTEC S.A., Vevey (CH)

(72) Inventors: Paola Olmos, Meriel (FR); Alina Maria Barniol Gutierrez, Beauvais (FR); Beatrice Jeannine Marie Bailleul, Allonne (FR)

(73) Assignee: NESTEC S.A., Vevey (CH)

(21) Appl. No.: 14/421,654

(22) PCT Filed: Jul. 23, 2013
(86) PCT No.: PCT/EP2013/065530

§ 371 Date: Feb. 13, 2015

(30) Foreign Application Priority Data
Aug. 22, 2012 (EP) 12181429.7

(51) Int. Cl. A23G 9/32; A23G 9/34; A23G 9/04

(52) U.S. Cl. CPC A23G 9/32; A23G 9/04; A23G 9/34; A23V 2002/00

(57) ABSTRACT

The invention relates to a shelf-or chilled-stable mix of food ingredients for the preparation of a frozen dessert, wherein i) the ingredients mix is in a non-frozen state and contained in an aseptic, closed, preferably sealed, packaging, and wherein ii) the ingredient mix comprises propylene glycol monoester of fatty acid, preferably propylene glycol monostearate (PGMS) as sole emulsifier or in combination with at least one further emulsifier for frozen desserts; iii) the salt content of the non-frozen mix is at least 70 mg/100 g product, and iiii) the non-frozen mix having a total solids content of less than 30%, preferably from 20 to 28%, and wherein optionally the ingredient mix may be aerated. The invention also relates to a method of making such a product.

### TECHNICAL FIELD OF THE INVENTION

The invention relates to a packaged shelf- or chilled-stable mix of ingredients for the preparation of a frozen confection, and especially to such a mix which will result in a frozen dessert with satisfying organoleptic properties when frozen quiescently at temperature higher than e.g. −24° C. The invention also concerns a process for the preparation of a frozen dessert comprising the quiescent freezing of a shelf- or chilled-stable mix at such temperatures.

### BACKGROUND OF THE INVENTION

A mix or foam quiescently frozen has the risk of developing an ice crystal structure which will be perceived as unpleasant by the consumers.

EP 2073644A1 teaches an aerated mix, including surface-active fibres, which can be quiescently frozen, i.e. without the presence of mechanical shear. Quiescent freezing according to this prior art—but also according to the invention—may be achieved through several means including: freezing in a domestic freezer, in a cold room, in liquid nitrogen, on solid carbon dioxide, or in a brine bath. Surface active agents, such as e.g. PGMS (propylene glycol monostearate) are said to be “not very good at providing long term foam stability”. Furthermore, according to this prior art, in ice cream, surface active agents are said to be added to both emulsify the oil phase and also to aerate the product during a shear freezing process.

EP 1926399 teaches an ingredient mix which may be processed by an aeration step followed by a quiescent freezing step. The mix uses hydrophobin (small proteins expressed only by certain fungi) for stabilising the gas bubbles both during storage between the aeration and freezing steps, and also during freezing. However, the use of hydrophobin does not solve ice crystal growth issues.

### BRIEF DESCRIPTION OF THE INVENTION

It is the object of the present invention to propose a product suitable for producing a frozen confection with good organoleptic and in particular a smooth texture in household conditions.

This object is achieved by means of the features of the independent claims. The dependent claims develop further the central idea of the present invention.

In a first aspect, the invention concerns a method for producing a frozen dessert, the method comprising the steps of
a) providing, in a closed, preferably sealed, packaging, a shelf- or chilled-stable non-frozen mix of ingredients
   i) the ingredients comprising propylene glycol monoester of fatty acid, preferably propylene glycol monostearate (PGMS) as sole emulsifier or in combination with at least one further emulsifier,
   ii) the salt content of the non-frozen mix being at least 70 mg/100 g product, and
   iii) the non-frozen mix having a total solids content of less than 30%, preferably from 20 to 28%, wherein optionally the ingredient mix may be aerated, and
b) thermally processing the mix to a temperature of at least 130° C.,
c) quiescently freezing the mix at a temperature between −12° C. and −24° C., preferably between −18° C. and −22° C.

In a second aspect, the invention relates to a shelf- or chilled-stable mix of food ingredients for the preparation of a frozen dessert, wherein i) the ingredients mix is in a non-frozen state and contained in an aseptic, closed, preferably sealed, packaging, and wherein ii) the ingredient mix comprises propylene glycol monoester of fatty acid, preferably propylene glycol monostearate (PGMS) as sole emulsifier or in combination with at least one further emulsifier for frozen desserts;
iii) the salt content of the non-frozen mix is at least 70 mg/100 g product, and iiii) the non-frozen mix having a total solids content of less than 30%, preferably from 20 to 28%, and wherein optionally the ingredient mix may be aerated.

### BRIEF DESCRITION OF THE FIGURE

FIG. 1 is photos of ice crystals in different products, including this invention.

### DETAILED DESCRIPTION OF THE INVENTION

Unless otherwise specified, percentages are meant to designate percentages by weight.

The inventors have found a non-frozen ingredient mix that can be stored over a longer period of time under ambient or chilled conditions, and will result in a satisfactory frozen dessert when frozen quiescently and at temperatures achievable with household freezing devices, in particular at temperature higher than −24° C.

What is meant by shelf-stable in the context of the invention is foods that by virtue of their form, formulation, or packaging can be stored for extended periods namely at least 4 weeks, preferably months or greater at ambient temperature without significant deterioration of quality (Australian Government, Department of Health and Aging).

What is meant by chilled-stable in the context of the invention is foods that by virtue of their form, formulation, or packaging is stored at maximum of 5° C. of temperature by a certain period of time until the moment of the product starts to suffer deterioration of quality.

What is meant by quiescent freezing in the context of the invention is subjecting a product to negative temperatures into a home freezer cabinet or other device where the product is kept statically at such temperature without any agitation, intervention or ventilation. This excludes hardening tunnel in factories.

Frozen desserts or frozen confections in the context of the invention include both aerated and non aerated confections to be consumed in a frozen state. Non limiting examples of frozen confections considered in the context of the invention include ice cream, sorbet, sherbet, frozen yogurt, frozen beverage, milk shake, gelato, mellorine and slush.

The inventors have found out that the use of propylene glycol monoester of fatty acid, preferably propyleneglycol monostearate (PGMS) in an ingredient mix for frozen dessert improves the organoleptic characteristics, in particular the smoothness, even when the mix is frozen quiescently, i.e. without mechanical shearing, and at temperatures achievable with household freezers.

The term “PGMS” is to be understood as encompassing any type of PGMS isomer. E.g. any PGMS isomer mentioned in the prior art document WO 2008/064675 can be used in the framework of the present invention.

The inventors have found out especially the following benefits:
The use of propylene glycol monoester of fatty acid allows skipping freezing and hardness step at factory level.
This allows having ambient/child transportation.
The addition of the propylene glycol monoester of fatty acid improves the smoothness of the resulting frozen dessert product, wherein quiescent freezing will lead to smoother texture than existing similar products (not having propylene glycol monoester of fatty acid).
This allows having self- or chilled-stable products that can be frozen in household conditions and which will result in the same smoothness than “standard” ice-cream produced at a factory.

The inventors observed that despite the low total solids of the product below 30% and in a preferred embodiment 27% the product presents a creamy and smooth texture, which is surprising. Products with this amount of total solids in general, present a very brittle texture, lack of body and poor textural attributes. Other similar examples currently in the market have a significant higher total solids content. For example, Gran Soleil from Ferrero has a total solid content of 36-42% and do have a smooth texture. However, this is expected since the high total solids can reduce the freezing point depression, thus providing a softer texture. Also the use of ethanol (0.5-3%) is a common practice to decrease the freezing point depression.

According to this invention, products that are free from ethanol may be provided.

Therefore, a first aspect of the invention relates to a method for producing a frozen confection, such as e.g. a sorbet or ice-cream, the method comprising the steps of:
providing, in a closed, preferably sealed packaging, a shelf-stable or chilled-stable non-frozen mix of ingredients, the ingredients comprising propylene glycol monoester of fatty acid, preferably PGMS as sole emulsifier or in combination with at least one further emulsifier, the salt content of the non-frozen mix is at least 70 mg/100 g product, and the non-frozen mix having a total solids content of less than 30%, preferably from 20 to 28%, wherein optionally the mix in the packaging is aerated and present as a foam, and thermally processing the mix to a temperature of at least 130° C., and quiescently freezing the mix at a temperature between −12° C. and −24° C., preferably between −18° C. and −22° C.

According to a preferred embodiment, the non frozen mix is essentially free from any acidic component. Preferably, the mix has a pH above 6.5, preferably pH from 6.5 to 8.5, more preferably a pH of 7. The salts used to achieve the desired pH can be organic or inorganic salts or acid regulators such as: sodium hydroxide, sodium phosphate, potassium phosphate, single phosphates, orthophosphates, polyphosphates or combinations thereof. The salt content in the present context is the salt added to the mix and the salt naturally present in the mix ingredients.

The thermal processing of the non-frozen mix is preferably done at a temperature above 130° C., more preferably by ultra high temperature.

The ingredient mix will be frozen while being in a sealed packaging. Preferably, the ingredient mix is aseptically packaged. This assures that the ingredient mix will not be contaminated while being frozen.

Propylene glycol monoester of fatty acid is preferably present in the ingredient mix in an amount of 0.08 weight % to 0.5 weight %, preferably 0.2 weight % to 0.4 weight %.

The inventors have found that this percentage of propylene glycol monoester of fatty acid leads to optimized organoleptic characteristics of the frozen dessert. In particular higher propylene glycol monoester of fatty acid content is providing unpleasant gelling mouth coating.

One or more of sorbitan tristearate, mono-diglycerides, diglycerides and monoglycerides may be provided as additional emulsifiers.

Mono-diglycerides preferably include mixtures of mono and diglycerides with a minimum of 40% monoglycerides. Monoglycerides are meant to designate product with less than 10% diglycerides. Preferably lightly unsaturated mono-diglycerides are used. The inventors have found out that these additional emulsifiers further improve the organolectic characteristics of the frozen dessert.

A further aspect of the invention proposes a shelf- or chilled-stable mix of ingredients for the preparation of a frozen dessert, the ingredients being in a non-frozen state and contained in an aseptic sealed packaging, the ingredients comprising propylene glycol monoester of fatty acid, preferably PGMS as sole emulsifier or in combination with at least one further emulsifier for a frozen desserts, the salt content of the non-frozen mix is at least 70 mg/100 g product, and the non-frozen mix having a total solids content of less than 30%, preferably from 20 to 28%, wherein optionally the ingredient mix may be aerated,.

According to a preferred embodiment, the non frozen mix is essentially free from any acidic component. Preferably, the mix has a pH above 6.5, preferably pH from 6.5 to 8.5, more preferably a pH of 7.

The ingredient mix is designed such that quiescent freezing of the ingredients, while being in the container, at a temperature between −10° C. and −24° C., preferably between −18° C. and −22° C., results in a frozen dessert with smooth texture.

The inventors have found out that on the one hand these temperatures lead to good organoleptic properties of the resulting frozen dessert. In addition, these temperatures can be easily achieved with household freezer equipment.

Propylene glycol monoester of fatty acid may be present in an amount of 0.08 weight % to 0.5 weight %, preferably 0.2 weight % to 0.4 weight % of the mix.

The shelf- or chilled-stable mix may comprise one or more of sorbitan tristearate, monoglycerides, diglycerides and mono-diglycerides.

The shelf- or chilled-stable mix may be free of fat.

Alternatively, the mix may comprise fat, preferably in an amount of between 1 weight % and 10 weight %, preferably between 2 weight % and 6 weight %.

The inventors have found out that even with this low amount of fat the frozen dessert will have desired organoleptic properties (smoothness).

The fat, when present, may be obtained from a vegetal source, such as e.g. coconut, and/or an animal source, preferably milk.

The shelf- or chilled-stable mix may comprise protein, preferably in an amount of between 0.5 weight % and 10 weight %, preferably between 1.5 weight % and 5 weight %. The protein preferably is milk protein or modifications thereof. Protein can be provided in particular through milk solids non fat which are preferably comprised in the mix of the invention in an amount of between 5 and 17 wt %, preferably 10 and 16 weight %

The mix may comprise a sweetening agent.

According to a particular embodiment, the mix further comprises one or more stabilizers. Suitable stabilizers include guar, carrageen, xanthan, gelatin, CMC, pectin, sodium alginate, locust bean gum, inuline and mixtures thereof. According to a preferred embodiment, the stabilizer is selected from the group consisting of guar, pectin, sodium alginate, and inuline and mixtures thereof. The stabilizer is preferably present in an amount comprised between 0.5 and 3 wt % of the end product.

The mix of the invention may be shelf-stable over a period of at least 4 weeks at ambient temperature or chilled-stable over the same period at a temperature between 1° C. and 8° C.

The shelf-stable mix may be free of alcohol and/or free of starch, surface-active fibers and/or hydrophobin.

This has advantages as to the taste and texture of the resulting frozen dessert.

The shelf/chilled-stable mix may be non-aerated (0% overrun). Alternatively, the mix in the packaging may be aerated with an overrun between 20% and 130%, preferably between 50% and 100%, or less than 30%. Thus, the mix may be present e.g. as a foamed ingredient mix.

A frozen dessert with smooth texture obtained by quiescent freezing at −10° C. to −24° C. of a packaged mix as described above is also an object of the invention.

Further features, advantages and objects of the present invention will become evident when reading the following detailed explanation of examples of the invention.

The invention proposes an unfrozen ingredient mix, which can be aerated or not, and which can be stored in a closed or sealed packaging, even over a longer period of time e.g. between four weeks and several months at room temperature or at chilled temperatures, but not in the frozen state.

The ingredient mix according to the invention is selected such that it can then be frozen under household conditions, i.e. temperatures which are achievable using household freezing equipment. The resulting frozen dessert will have a smooth texture, which will not be perceived as crystallized by the consumer even when frozen quiescently, i.e. without mechanical sheering, as it typically occurs in household conditions.

### EXAMPLES

### Example 1

The inventors have successfully obtained a statically frozen product with the following ice-cream formulation 1:
5% fat (cream)
28% TS (total solids)
13% MSNF (milk solid not fat)
2,5% protein(s)

Stabilizers (0.8%): high methoxyl pectin, sodium alginate, inuline, guar.

Furthermore, as a sole emulsifier, 0.3% PGMS is added.

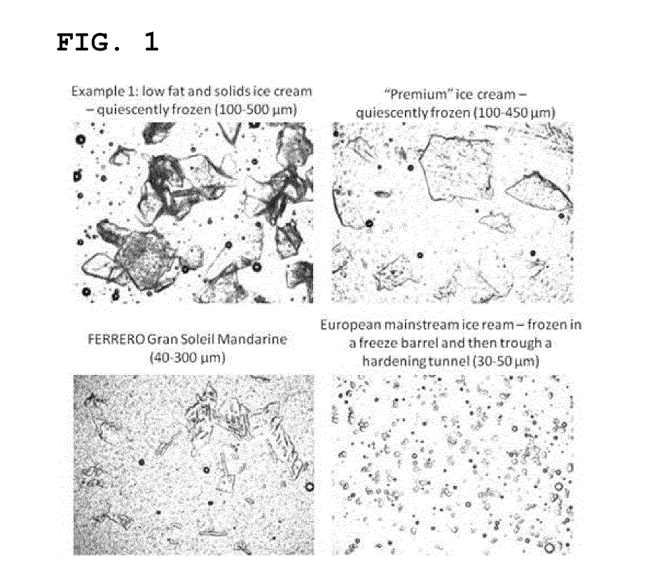

### Example 2, FIG. 1

FIG. 1 shows photos comparing the ice crystal size in different products, comparing existing product with the product of the invention. Current product considered as standard “mainstream ice cream” have an ice crystal size of 30-50 μm. The product of this invention has a particle size significantly higher than standard ice cream, despite this fact; the product delivers a smooth and creamy texture. The photos are taken with Direct light microscopy.

### Example 3

The smoothness of the resulting ice-cream products from Example 1 has been evaluated by a tasting panel:

### Technical Tasting:

A panel of 7 trained people on ice cream tasting was asked to compare the texture of 2 different ice cream formulations, one the invention formula of example 1 and the reference product-same formula without PGMS). Following attributes were evaluated: hardness, stickiness, coldness, melting rate, smoothness, chewiness and mouth coating.

The average of panel resulted in the example 1 being significantly more smooth than the reference product.

The panel confirmed that the smoothness of the resulting ice-cream product is increased by the above recipes, in comparison to ice-cream products which have been obtained using the same recipe, but without PGMS.

Example 4

Processes for the preparation of a frozen dessert according to the present invention are given below:

### Option 1:

1. The ingredients including the PGMS, are mixed and homogeneized

2. This raw mix is then packaged and sterilized by retort.
This aseptic packed mix can be distributed at ambient or child temperatures. The consumer or any other following user (e.g. point of sell) can freeze this packed dessert in a cabinet e.g. at −18° C. to obtain a frozen dessert as pleasant as standard ice cream.

As an alternative, the mix is UHT processed to reach sterility, then can be aseptically packed and distributed at ambient or child temperatures. The consumer or any other following user (e.g. point of sell) can freeze this packed dessert in a cabinet e.g. at −18° C. to obtain a frozen dessert as pleasant as standard ice cream.

### Option 2:

1. The sterilized UHT ingredient mix can be aseptically whipped to be foamed, e.g. by having an overrun from 20% to 130%. It can be directly statically frozen.

Alternatively, the sterilized UHT mix, which has been aseptically foamed can be aseptically packed and distributed at ambient or child temperatures. The consumer or the point of sales can freeze quiescently this packed dessert in a cabinet at −18° C.

1. A method for producing a frozen dessert, comprising the steps of
providing, in a closed packaging, a shelf- or chilled-stable non-frozen mix of ingredients
comprising propylene glycol monoester of fatty acid, preferably propylene glycol monostearate (PGMS) as sole emulsifier or in combination with at least one further emulsifier,
the salt content of the non-frozen mix is at least 70 mg/100 g product, and
the non-frozen mix having a total solids content of less than 30%;
thermally processing the mix to a temperature of at least 130° C.: and
quiescently freezing the mix at a temperature between −12° C. and −24° C.

2. The method of claim 1, wherein the thermal processing of the non-frozen mix is done by ultra high temperature.

3. The method of claim 1, wherein the non-frozen mix has a freezing point depression from −1° C. to −3° C.

4. The method of claim 1, wherein the process comprises adjusting the pH of the mix to a pH from 6.5 to 8.5.

5. The method according to claim 1, comprising the step of aseptically packaging the mix of ingredients prior to the quiescent freezing.

6. The method according to claim 1, wherein the propylene glycol monoester of fatty acid, is present in an amount of 0.08 weight % to 0.5 weight %, of the mix.

7. The method according to claim 1, wherein an ingredient selected from the group consisting_of sorbitan tristearate, diglycerides, mono-diglycerides and monoglycerides is provided as an additional emulsifier.

8. A shelf- or chilled-stable mix of food ingredients for the preparation of a frozen dessert, wherein:
the ingredients mix is in a non-frozen state and contained in an aseptic, closed, preferably sealed, packaging;
the ingredient mix comprises propylene glycol monoester of fatty acid, preferably propylene glycol monostearate (PGMS) as sole emulsifier or in combination with at least one further emulsifier for frozen desserts;
the salt content of the non-frozen mix is at least 70 mg/100 g product; and
the non-frozen mix having a total solids content of less than 30%.

9. The mix of claim 8,
wherein the propylene glycol monoester of fatty acid is present in an amount of 0.08 weight % to 0.5 weight %, of the mix.

10. The mix of claim 8,
comprising one or more of sorbitan tristearate, diglycerides, mono-diglycerides and monoglycerides.

11. The mix of claim 8, being free of fat.

12. The mix of claim 8,
comprising protein.

13. The mix of claim 8,
which is shelf stable over a period of at least 4 weeks at ambient temperature or chilled stable over a period of at least 4 weeks at a temperature between 1° C. and 8° C.

14. The mix of claim 8,
which has a content of less than 0.5% of at least one ingredient selected from the group consisting of:
alcohol
starch
surface-active fibers, and/or
hydrophobin
acidic component.

15. The mix of claim 8,
which is non-aerated.

16. The mix of claim 8,
comprising one or more stabilizer selected from the group consisting of guar, carrageen, xanthan, gelatin, inuline, pectin, sodium alginate, locust bean gum and mixtures thereof.

17. The mix of claim 8, wherein the non-frozen mix has a freezing point depression from −1° C. to −3° C.

18. Frozen dessert with smooth texture wherein:
the ingredients mix is in a non-frozen state and contained in an aseptic, closed, preferably sealed, packaging;
the ingredient mix comprises propylene glycol monoester of fatty acid, preferably propylene glycol monostearate (PGMS) as sole emulsifier or in combination with at least one further emulsifier for frozen desserts;
the salt content of the non-frozen mix is at least 70 mg/100 g product; and
the non-frozen mix having a total solids content of less than 30%, and the dessert is obtained by quiescently freezing the mix at a temperature between −10° C. and −24°.

19. The mix of claim 8,
not comprising at least one ingredient selected from the group consisting of:
alcohol;
starch;
surface-active fibers,
hydrophobin; and
an acidic component.

20. The mix of claim 8,
which is aerated with an overrun between 20% and 130%.
